(19) United States
(12) Patent Application Publication
(10) Pub. No.: US 2019/0005933 A1
(43) Pub. Date: Jan. 3, 2019

(54) Method for Selectively Muting a Portion of a Digital Audio File

(71) Applicant: Michael Sharp, Porter, TX (US)

(72) Inventor: Michael Sharp, Porter, TX (US)

(21) Appl. No.: 16/022,468

(22) Filed: Jun. 28, 2018

Related U.S. Application Data
(60) Provisional application No. 62/526,085, filed on Jun. 28, 2017.

(51) Int. Cl. G10H 1/36; G10H 1/00; G11B 27/034

(52) U.S. Cl. CPC G10H 1/365; G11B 27/034; G10H 1/0033

(57) ABSTRACT

A method for selectively muting a portion of a digital audio file has a user account that is associated to a PC device and is managed by a remote server. The system for executing the method has a set of playback modulation processes that enable the user to control how an audio file is played. The method begins by inputting the audio file into a splitter process in order to identify a set of distinct audio tracks. The method then identifies every word found in the audio file and synchronizes a textual transcript of the words with a timeline of the song. The user is then prompted to mute a desired track from the set of distinct audio tracks. Additionally, the user can select a desired process to further manipulate one or more distinct tracks from the set of distinct audio tracks.

The current application claims a priority to the U.S. Provisional Patent application Ser. No. 62/526,085 filed on Jun. 28, 2017.

### FIELD OF THE INVENTION

The present invention relates generally to a method for controlling music playback. More specifically, the present invention relates to a method for selectively modulating one or more audio channels found within an audio file.

### BACKGROUND OF THE INVENTION

Singing is one of the popular leisure activities. Many people try to learn singing for leisure. Further, many people learn singing to become professional singers. Some people using devices like karaoke players to learn music.

However, often people want to listen to the original track as they practice singing. This helps them calibrate their voice, tone etc. to match the singing of the original singer. However, it is difficult to quickly access the original track while they are practicing signing.

Accordingly, there is a need for methods and systems for efficiently and effectively sync and play music to assist people to learn music.

### BRIEF DESCRIPTION OF THE DRAWINGS

FIG. 1 is a block diagram illustrating the system overview of the present invention.

FIG. 2 is a flowchart describing the overall process followed by the method of the present invention.

FIG. 3 is flowchart describing a sub-process for selectively muting the synchronized vocal track or the instrumental track through the method of the present invention.

FIG. 4 is flowchart describing a sub-process for selectively modulating the synchronized vocal track or the instrumental track through the method of the present invention.

FIG. 5 is flowchart describing a sub-process for identifying a plurality of distinct words within the synchronized vocal track through the method of the present invention.

FIG. 6 is flowchart describing a sub-process for generating a transcript of the synchronized vocal track through the method of the present invention.

FIG. 7 is flowchart describing a sub-process for generating a synthesizer instruction set for the instrumental track through the method of the present invention.

FIG. 8 is flowchart describing a sub-process for identifying and executing an optimized add campaign through the method of the present invention.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

According to some aspects, the present disclosure provides a teaching tool for teaching singing songs to users.

According to some aspects, the present disclosure provides a system that allows users the convenience of muting the vocal on a song simply by pressing the mute button on a multimedia player.

According to some aspects, the present disclosure provides a timeline sequence algorithm that adjusts the tempo for both audio tracks (original audio track and recreated audio track without vocals) then allows for syncing, stretching and beat match, so that the two audio tracks are perfectly aligned and in sync. The timeline sequence algorithm uses two individual audio tracks to create enhanced content for a music player.

According to some aspects, the present disclosure provides a music player with mute voice capability that may display lyrics (as an option) giving users a karaoke plus original vocal to help them learn the song. The user may rewind the player and stop-start at any time during playback. In other words, the vocals may be muted by activating the mute button, so that only a recreated audio track (without vocals) is heard. This process may be repeated at will giving the user a teaching tool that conveniently allows the original singer to be heard or canceled out at by simply rolling over the mute option.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### DETAIL DESCRIPTIONS OF THE INVENTION

All illustrations of the drawings are for the purpose of describing selected versions of the present invention and are not intended to limit the scope of the present invention.

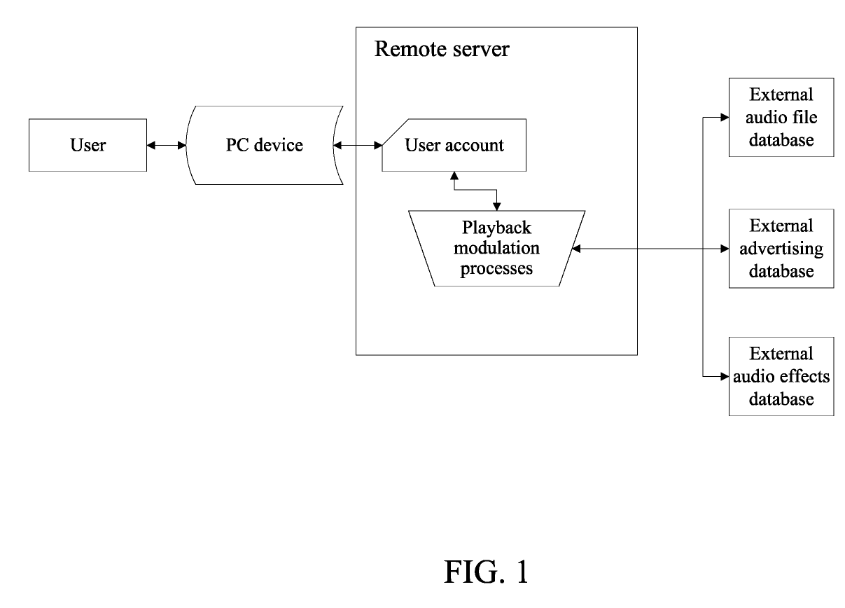

Referring to FIG. 1 through FIG. 8, the present invention, the method for selectively muting a portion of a digital audio file, is a method that enables a user to modulate and control the playback characteristic of the digital audio file. To facilitate this, the method of the present invention employs a series of sub-processes to dynamically split the digital audio file into several discrete audio tracks. The method of the present invention then enables the user to adjust how each discrete audio track is then output. For example, when the digital audio file is a music file, the method of the present invention can be used to split the music file into a vocal track and an instrumental track. The user is then given the option to play the entire music file, or to mute either the vocal track or the instrumental track during playback.

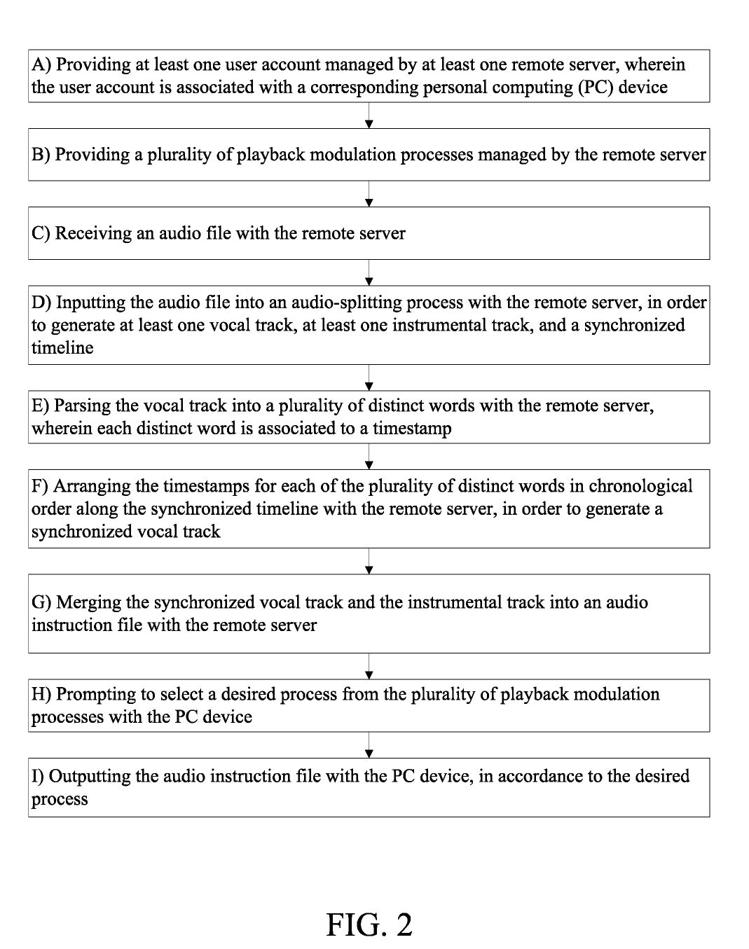

Referring to FIG. 2, to achieve the aforementioned functionalities, the present invention makes use of a system capable of receiving user input, outputting system information, and communicating data between a distributed network of devices. Specifically, the system for executing the method of the present invention includes at least one user account managed by at least one remote server (Step A). The user account is associated with a personal computing (PC) device. The PC device used to interact with the present invention can be, but is not limited to, a smart-phone, a laptop, a desktop, or a tablet PC. Additionally, the PC device includes at least one speaker and a display device. Thus, enabling the user to audibly output the digital audio file and view relevant system information. The remote server is used to facilitate communication between the user account and external music databases. Moreover, the remote server is used to execute a number of internal processes for the present invention and is used to perform a set of audio manipulation processes. The system used to execute the method of the present invention provides a plurality of playback modulation processes managed by the remote server (Step B). Each of the plurality of playback modulation processes is a sub-process that enables the user to control how the digital audio file is audibly output through the PC device. Further, the plurality of playback modulation processes enables the user to employ the method of the present invention to visually output system information that is related to the digital audio file. For example, the user may choose to view the lyrics of associated with the music file.

Referring to FIG. 2, the overall method of the present invention is a process that is used to split a digital audio file into a collection of audio tracks, where each track includes audio information that is associated with a discrete portion of the digital audio file. Additionally, the overall method of the present invention enables the user to modulate the playback of the collection of audio tracks. As such, the overall method of the present invention begins by receiving an audio file with the remote server (Step C). The method of the present invention is designed to enable the user to import audio files that have not been processed and split into the collection of audio tracks. Additionally, the method of the present invention is designed to source digital audio files from external databases that have not been processed and split into the collection of audio tracks. As a result, the method of the present invention enables the user to modulate the playback of a wide variety of digital audio files. The overall method of the present invention continues by inputting the audio file into an audio-splitting process with the remote server, in order to generate at least one vocal track, at least one instrumental track, and a synchronized timeline (Step D). The audio splitting process is a routine that identifies the discrete audio tracks contained within the digital audio file, and then separates the digital audio file into the collection of audio tracks. The at least one vocal track is a discrete audio track that includes only the voice data of a song. Additionally, the audio-splitting process may be employed to create a plurality of vocal tracks when the digital audio file includes multiple vocalists. In this scenario each vocal track is dedicated to a single vocalist. Similarly, the at least one instrumental track is a discrete audio track that includes only the instrumental data of a song. Likewise, the audio-splitting process may be employed to create a plurality of instrumental tracks when the digital audio file includes multiple instrumentalists. In this scenario each instrumental track is dedicated to a single instrumentalist. The synchronized timeline is a timetable that tracks the duration of the digital audio file.

Referring to FIG. 2, once the digital audio file is split into the collection of audio tracks, the overall method of the present invention is able to perform post processing and create an instruction file that directs the PC device to output the correct information during playback. To accomplish this, the overall method of the present invention continues by parsing the vocal track into a plurality of distinct words with the remote server (Step E). The plurality of distinct words is a collection of audio tokens, each of which contains a single word that is spoken by the vocalist. That is, every word that is sung by the vocalist is identified and then assigned a timestamp. The timestamp identifies where the distinct word was spoken during the audio track and how long the distinct word took to speak. As a result, the method of the method of the present invention is able to identify artistically shortened or elongated words. The overall method of the present invention continues by arranging the timestamps for each of the plurality of distinct words in chronological order along the synchronized timeline with the remote server, in order to generate a synchronized vocal track (Step F). The synchronized vocal track is a discrete audio track that contains the raw vocal data and a record that includes information that further specifies the position, content, and duration of each distinct word. The overall method of the present invention continues by merging the synchronized vocal track and the instrumental track into an audio instruction file with the remote server (Step G). The audio instruction file includes formatted data that directs the PC device to output the appropriate data. For example, the audio instruction file may use the Musical Instrument Digital Interface (MIDI) to format the instrumental track. As such, the audio instruction file includes data that describes the vocal track and instructions that direct the PC device to generate the appropriate audio output. The overall method of the present invention continues by prompting to select a desired process from the plurality of playback modulation processes with the PC device (Step H). The overall method of the present invention continues by outputting the audio instruction file with the PC device, in accordance to the desired process (Step I). As a result, the method of the present invention enables the user to select the desired operations that will be used to control the playback of the digital audio file. For example, the user can mute, modulate, and view information about each of the discrete audio tracks.

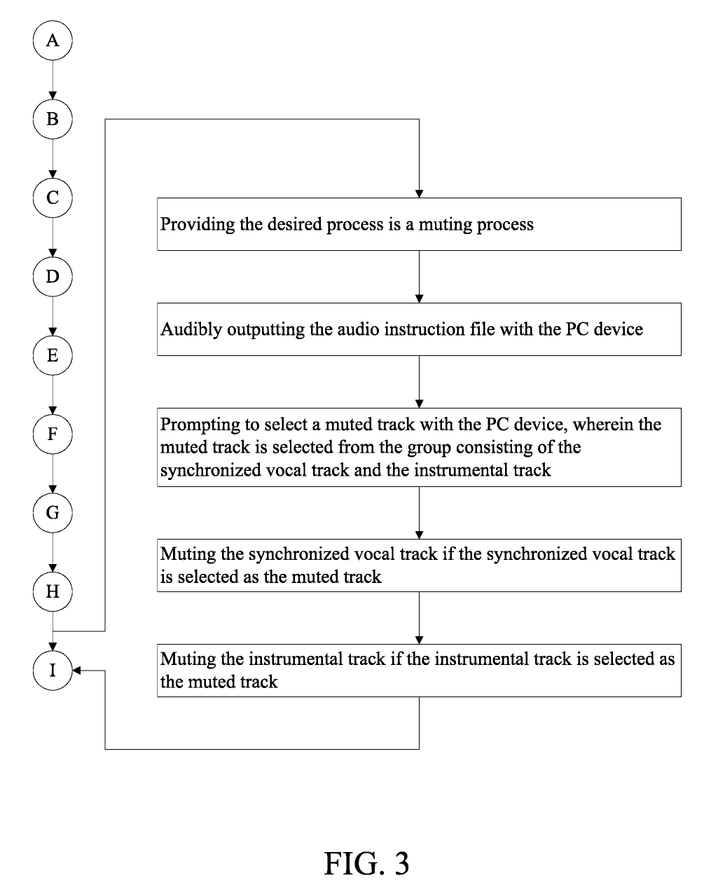

Referring to FIG. 3, the method of the present invention is designed to enable the user to mute and unmute the vocal track and the instrumental track as desired. To achieve this, the user selects a muting process as the desired process. Once selected, the sub-process begins by audibly outputting the audio instruction file with the PC device. Accordingly, the sub-process begins playing the unaltered audio instruction file with the PC device. The sub-process continues by prompting to select a muted track with the PC device. The user is prompted to select the muted track from the synchronized vocal track and the instrumental track. The sub-process continues by muting the synchronized vocal track if the synchronized vocal track is selected as the muted track. Alternatively, the sub-process continues by muting the instrumental track if the instrumental track is selected as the muted track. Consequently, the user is able to mute and unmute any of the audio tracks included in the audio instruction file.

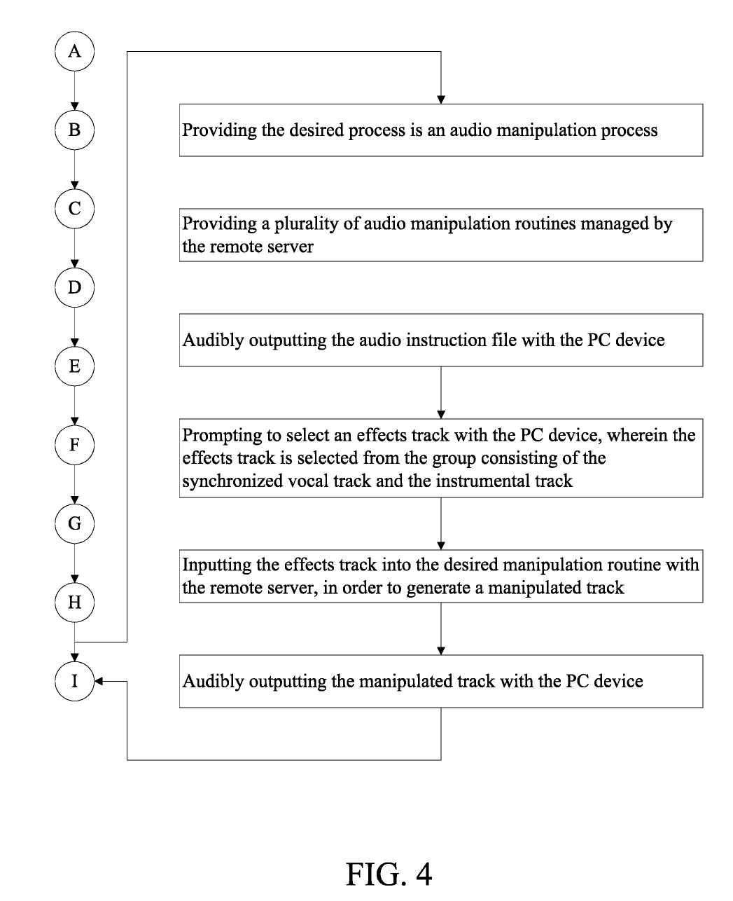

Referring to FIG. 4, the method of the present invention is designed to enable the user to manipulate how the audio instruction file is output by the PC device. To achieve this, the user selects an audio manipulation process as the desired process. Additionally, the system for executing the method of the present invention provides a plurality of audio manipulation routines managed by the remote server. The plurality of audio manipulation processes is a collection of routines that are used to add audio effects to the synchronized vocal track and the instrumental track. For example, the user may add autotuning to the synchronized vocal track by selecting the appropriate audio manipulation routine. The PC device will then output the autotuned vocal track. Once selected, the sub-process begins by audibly outputting the audio instruction file with the PC device. Accordingly, the sub-process begins playing the unaltered audio instruction file with the PC device. The sub-process continues by prompting to select an effects track with the PC device. Specifically, the user is prompted to select a track from the synchronized vocal track and the instrumental track that will be manipulated. The sub-process continues by prompting to select a desired manipulation routine with the PC device. The desired manipulation is one of the plurality of audio manipulation routines. Accordingly, the user is able to control how each aspect of the audio instruction file should be output by the PC device. The sub-process continues by inputting the effects track into the desired manipulation routine with the remote server, in order to generate a manipulated track. Further, the sub-process continues by audibly outputting the manipulated track with the PC device. Accordingly, the PC device is directed to output the synchronized vocal track and the instrumental track ad modified by the desired manipulation routine. For example, the user may select the synchronized vocal track as the effects track and may select an autotuning routine as the desired manipulation routine. The synchronized vocal track will then be played with tan autotune effect. The method of the present invention is designed to enable the user to modify and play a plurality of audio tracks, simultaneously. As such, the user may then sect the instrumental track as the effects track and a reverberation routine as the desired manipulation routine. In this scenario the PC device will be directed to output the autotuned synchronized vocal track and the reverberation adjusted instrumental track simultaneously.

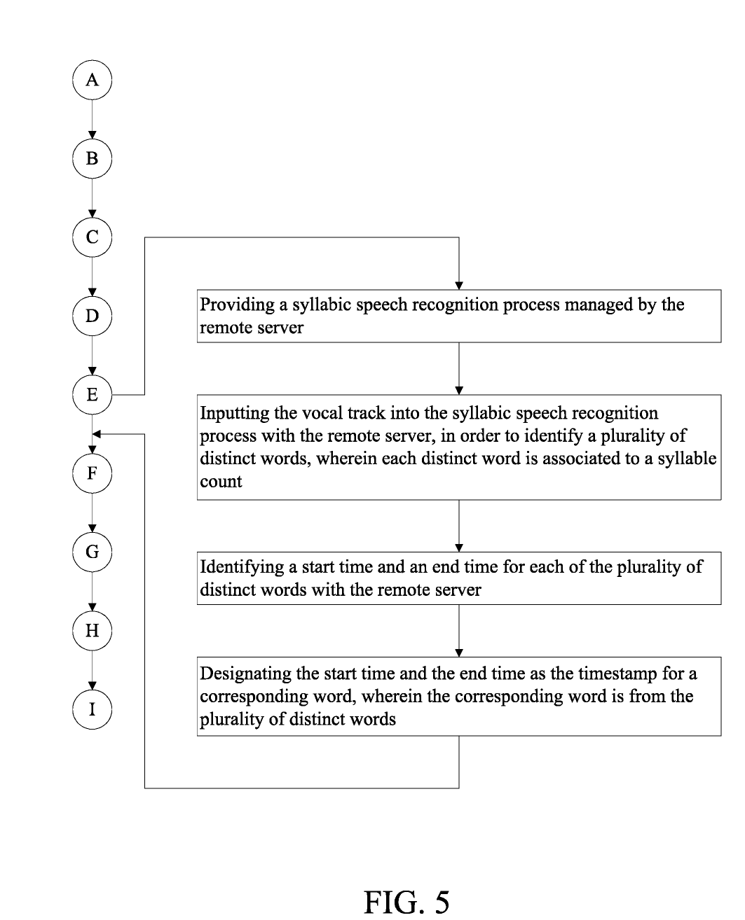

Referring to FIG. 5, the method of the present invention is designed to analyze the vocal track in order to identify the words spoken by the vocalist, as well as any artistic flair that changes the general construction of each word. To achieve this, the method of the present invention includes a providing a syllabic speech recognition process managed by the remote server. The syllabic speech recognition process is a sub-process that analyses the composition of spoken words and generates a collection of verbal characteristics. This sub-process begins by inputting the vocal track into the syllabic speech recognition process with the remote server, in order to identify a plurality of distinct words. The plurality of distinct words is a collection of words that are spoken by the vocalist. Additionally, each distinct word is associated to a syllable count. Accordingly, the syllable count represents any artistic flair that the vocalist may have used when singing each of the distinct words. The sub-process continues by identifying a start time and an end time for each of the plurality of distinct words with the remote server. Further, the sub-process continues by designating the start time and the end time as the timestamp for a corresponding word from the plurality of distinct words. Consequently, each distinct word is identified, the artistic characteristics are quantified, and the temporal specificity is defined.

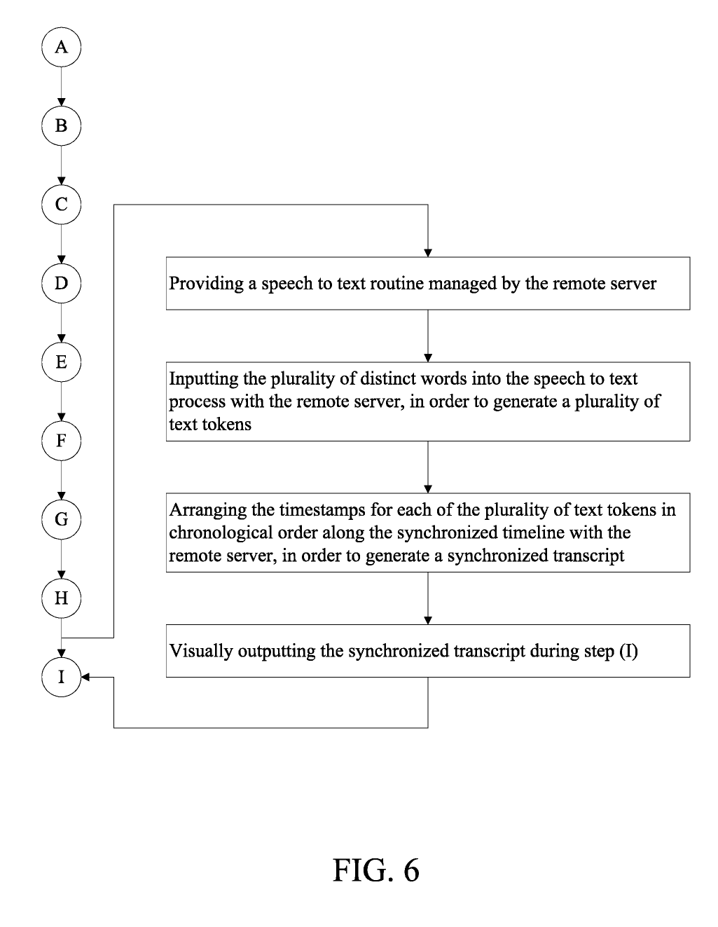

Referring to FIG. 6, the method of the present invention is designed with a sub-routine for generating transcripts of the distinct words included in the synchronized vocal track. Specifically, the system for executing the method of the present invention provides a speech to text routine managed by the remote server. This sub-routine begins by inputting the plurality of distinct words into the speech to text process with the remote server, in order to generate a plurality of text tokens. The plurality of text tokens is a collection of textual representations for each of the distinct words. Accordingly, the sub-routine generates a textual representation of the words spoken by the vocalist. The sub-routine continues by arranging the timestamps for each of the plurality of text tokens in chronological order along the synchronized timeline with the remote server, in order to generate a synchronized transcript. The synchronized transcript is a representation of the plurality of distinct words that has been formatted chronologically. The sub-routine concludes by visually outputting the synchronized transcript during Step I. Consequently, the user is able to view the lyrics of the audio instruction file while the audio instruction file is playing. Further, the transcript is designed to represent the artistic flair used by the vocalist.

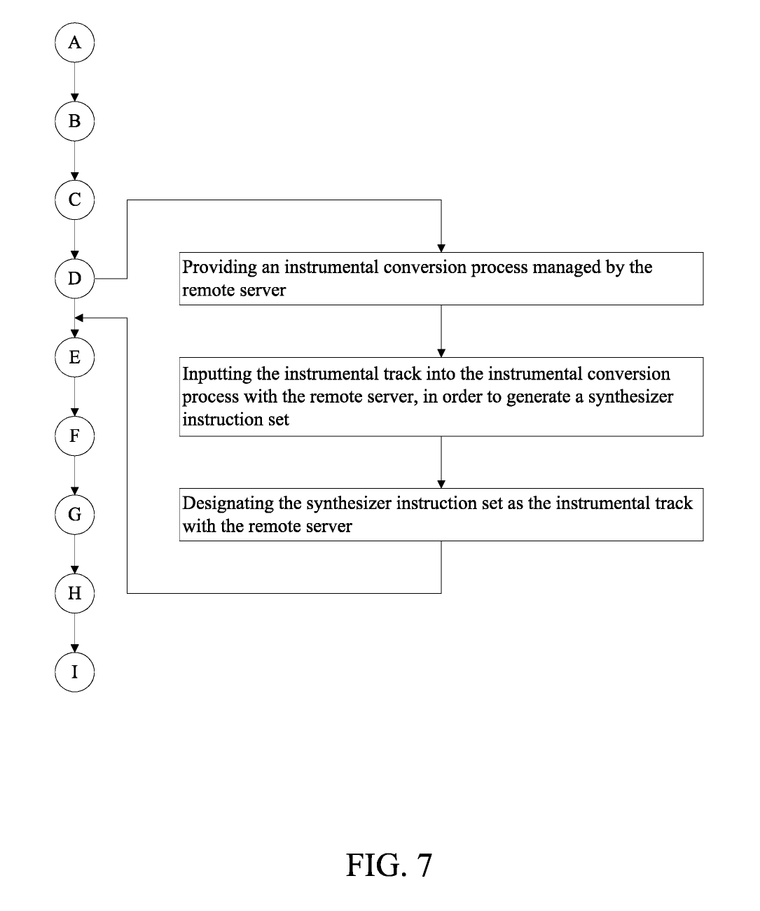

Referring to FIG. 7, in addition to generating a synchronized transcript, the method of the present invention is designed to convert the instrumental track into a universally accepted synchronizer instruction set. To that end, the method of the present invention provides an instrumental conversion process managed by the remote server. Specifically, the sub-process begins by inputting the instrumental track into the instrumental conversion process with the remote server, in order to generate a synthesizer instruction set. Consequently, the instrumental conversion process generates an instruction set that directs the synthesizer for the PC device to generate the appropriate audio output. The sub-process continues by designating the synthesizer instruction set as the instrumental track with the remote server. Accordingly, the instrumental track directs the synthesizer to generate accurate audio output.

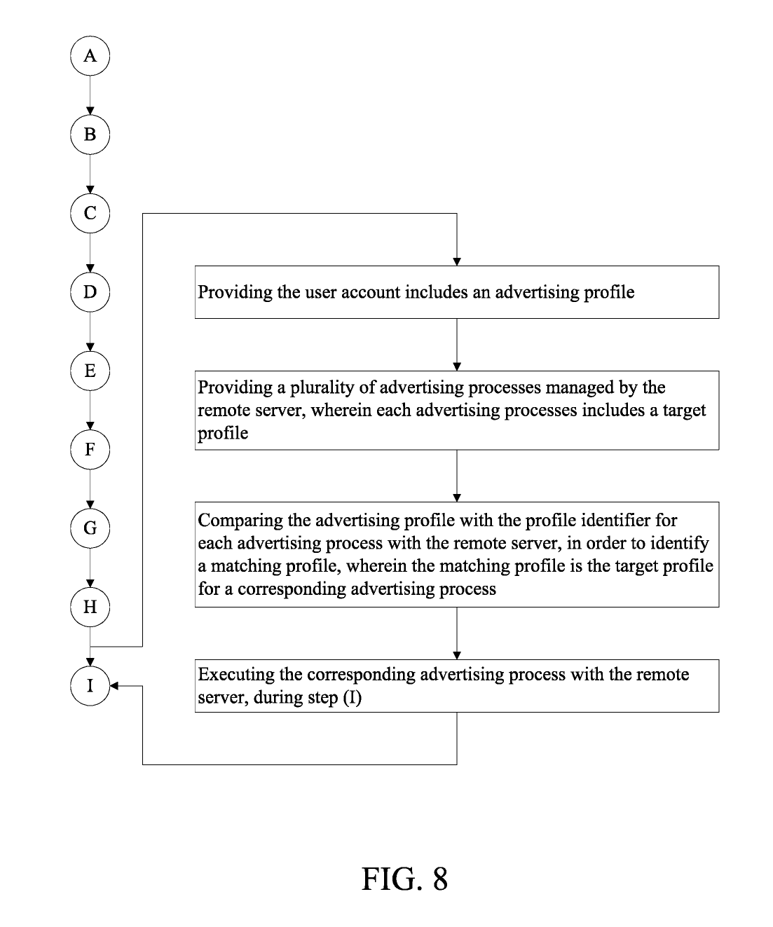

Referring to FIG. 8, the present invention is designed to have an integrated advertisement system. To that end, the system for executing the method of the present invention provides an advertising profile that is included in each user account. The advertising profile includes personal data about the user. This data is used to identify the types of advertisement to which the user will be receptive. The advertising functionality is enabled by providing a plurality of advertising processes managed by the remote server. Each advertising process is a sub-process that describes a specific advertising campaign. As such, each advertising process includes a target profile. The target profile is a descriptor that characterizes the type of user that will respond to the specific advertising campaign. The sub-process begins by comparing the advertising profile with the profile identifier for each advertising process with the remote server, in order to identify a matching profile. The matching profile is the target profile that accurately describes the user being presented with the advertising campaign. The sub-process continues by executing the corresponding advertising process with the remote server, during Step I. Accordingly, the user will be presented with an advertising campaign that is highly effective.

Although the invention has been explained in relation to its preferred embodiment, it is to be understood that many other possible modifications and variations can be made without departing from the spirit and scope of the invention as hereinafter claimed.

What is claimed is:

1. A method for selectively muting a portion of a digital audio file, the method comprising the steps of:
(A) providing at least one user account managed by at least one remote server, wherein the user account is associated with a corresponding personal computing (PC) device;
(B) providing a plurality of playback modulation processes managed by the remote server;
(C) receiving an audio file with the remote server;
(D) inputting the audio file into an audio-splitting process with the remote server, in order to generate at least one vocal track, at least one instrumental track, and a synchronized timeline;
(E) parsing the vocal track into a plurality of distinct words with the remote server, wherein each distinct word is associated to a timestamp;
(F) arranging the timestamps for each of the plurality of distinct words in chronological order along the synchronized timeline with the remote server, in order to generate a synchronized vocal track;
(G) merging the synchronized vocal track and the instrumental track into an audio instruction file with the remote server;
(H) prompting to select a desired process from the plurality of playback modulation processes with the PC device;
(I) outputting the audio instruction file with the PC device, in accordance to the desired process;

2. The method for selectively muting a portion of a digital audio file, the method as claimed in claim 1 comprising the steps of:
providing the desired process is a muting process;
audibly outputting the audio instruction file with the PC device;
prompting to select a muted track with the PC device, wherein the muted track is selected from the group consisting of the synchronized vocal track and the instrumental track;
muting the synchronized vocal track if the synchronized vocal track is selected as the muted track;
muting the instrumental track if the instrumental track is selected as the muted track;

3. The method for selectively muting a portion of a digital audio file, the method as claimed in claim 1 comprising the steps of:
providing the desired process is an audio manipulation process;
providing a plurality of audio manipulation routines managed by the remote server;
audibly outputting the audio instruction file with the PC device;
prompting to select an effects track with the PC device, wherein the effects track is selected from the group consisting of the synchronized vocal track and the instrumental track;
prompting to select a desired manipulation routine with the PC device, wherein the desired manipulation routine is from the plurality of audio manipulation routines;
inputting the effects track into the desired manipulation routine with the remote server, in order to generate a manipulated track;
audibly outputting the manipulated track with the PC device;

4. The method for selectively muting a portion of a digital audio file, the method as claimed in claim 1 comprising the steps of:
providing a syllabic speech recognition process managed by the remote server;
inputting the vocal track into the syllabic speech recognition process with the remote server, in order to identify a plurality of distinct words, wherein each distinct word is associated to a syllable count;
identifying a start time and an end time for each of the plurality of distinct words with the remote server;
designating the start time and the end time as the timestamp for a corresponding word, wherein the corresponding word is from the plurality of distinct words;

5. The method for selectively muting a portion of a digital audio file, the method as claimed in claim 4 comprising the steps of:
providing a speech to text routine managed by the remote server;
inputting the plurality of distinct words into the speech to text process with the remote server, in order to generate a plurality of text tokens;
arranging the timestamps for each of the plurality of text tokens in chronological order along the synchronized timeline with the remote server, in order to generate a synchronized transcript;
visually outputting the synchronized transcript during step (I);

6. The method for selectively muting a portion of a digital audio file, the method as claimed in claim 1 comprising the steps of:
providing an instrumental conversion process managed by the remote server;
inputting the instrumental track into the instrumental conversion process with the remote server, in order to generate a synthesizer instruction set;
designating the synthesizer instruction set as the instrumental track with the remote server;

7. The method for selectively muting a portion of a digital audio file, the method as claimed in claim 1 comprising the steps of:
providing the user account includes an advertising profile;
providing a plurality of advertising processes managed by the remote server, wherein each advertising processes includes a target profile;
comparing the advertising profile with the profile identifier for each advertising process with the remote server, in order to identify a matching profile, wherein the matching profile is the target profile for a corresponding advertising process;
executing the corresponding advertising process with the remote server, during step (I);
